(19) United States
(12) Patent Application Publication
(10) Pub. No.: US 2006/0146574 A1
(43) Pub. Date: Jul. 6, 2006

(54) Compact backlight module

(75) Inventors: Zhi-Feng Fu, Shenzhen (CN); Yu-Liang Huang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/317,748

(22) Filed: Dec. 23, 2005

(30) Foreign Application Priority Data
Dec. 30, 2004 (CN) 200420103611.0

(51) Int. Cl. F21V 7/04; A47F 3/00

(52) U.S. Cl. 362/621; 362/26; 362/614; 362/628; 362/561

(57) ABSTRACT

A backlight module (5) includes a light guide plate (51) and a light source (52). The light guide plate includes a first light incident surface (510), a second light incident surface (512) adjacent the first light incident surface. The first light incident surface and the second light incident surface cooperatively define a first groove (54) therebetween. The light source is disposed in the first groove. With this configuration, there is no need for additional space for the light source beyond an end of the light guide plate. Thus an overall length of the backlight module is shortened. Furthermore, a top end (533) of the reflector can be disposed in a second groove (59) defined between two adjacent side surfaces at the end of the light guide plate. Thus an overall height of the backlight module is shortened. The reduced overall length and height of the backlight module makes it compact.

### FIELD OF THE INVENTION

The present invention relates to backlight modules, and especially to a backlight module typically used for a liquid crystal display (LCD).

### BACKGROUND

Liquid crystal displays are commonly used as display devices for compact electronic apparatuses, because they not only provide good quality images with little power but also are very thin. The liquid crystals in a liquid crystal display do not emit any light themselves. The liquid crystals have to be lit by a light source so as to clearly and sharply display text and images. Thus, a backlight module for an LCD is generally needed.

Referring to FIG. 7 and FIG. 8, a typical backlight module 1 includes a light guide plate (LGP) 11, a light source 12, and a reflector 13. The LGP 11 includes a light incident surface 115, a light emitting surface 111 adjoining the light incident surface 115, and a bottom surface 113 opposite to the light emitting surface 111. The light source 12 is disposed adjacent to the light incident surface 115 of the LGP 11, and the reflector 13 is disposed adjacent to a top and a rear of the light source 12. The reflector 13 includes a top end 133 attached at the light emitting surface 111 of the LGP 11.

Light beams emitted by the light source 12 enter the LGP 11 through the light incident surface 115, and then are emitted from the light emitting surface 111 of the LGP 11. The reflector 13 can reflect some light beams from the light source 12 toward the LGP 11, for improving a ratio of light utilization of the backlight module 1.

The light source 12 is disposed adjacent to the light incident surface 115 of the LGP 11, which adds to an overall length of the backlight module 1. Further, the top end 133 of the reflector 13 is attached at the light emitting surface 111, which adds to an overall height of the backlight module 1.

What is needed, therefore, is a compact backlight module.

### SUMMARY

A backlight module is provided. The backlight module includes a light guide plate and a light source. The light guide plate includes a first light incident surface, a second light incident surface adjacent the first light incident surface. The first light incident surface and the second light incident surface cooperatively define a first groove therebetween. The light source is disposed in the first groove.

With this configuration, there is no need for additional space for the light source beyond an end of the light guide plate. Thus an overall length of the backlight module is shortened. Furthermore, a top end of the reflector can be disposed in a second groove, which can be defined between two adjacent side surfaces at the end of the light guide plate. Thus an overall height of the backlight module is shortened. The reduced overall length and height of the backlight module makes it compact.

Other advantages and novel features will become more apparent from the following detailed description of preferred embodiments when taken in conjunction with the accompanying drawings, in which:

### BRIEF DESCRIPTION OF THE DRAWINGS

FIG. 1 is a schematic, isometric view of a backlight module according to a first embodiment of the present invention;

FIG. 2 is a side view of the backlight module shown in FIG. 1;

FIG. 3 is an enlarged view of a circled portion III of FIG. 2;

FIG. 4 is a schematic, isometric view of a backlight module according to a second embodiment of the present invention;

FIG. 5 is a side view of the backlight module shown in FIG. 4;

FIG. 6 is an enlarged view of a circled portion VI of FIG. 5;

FIG. 7 is a schematic, isometric view of a conventional backlight module; and

FIG. 8 is a side view of the backlight module shown in FIG. 7.

### DETAILED DESCRIPTION OF PREFERRED EMBODIMENTS

Reference will now be made to the drawings to describe the preferred embodiments in detail.

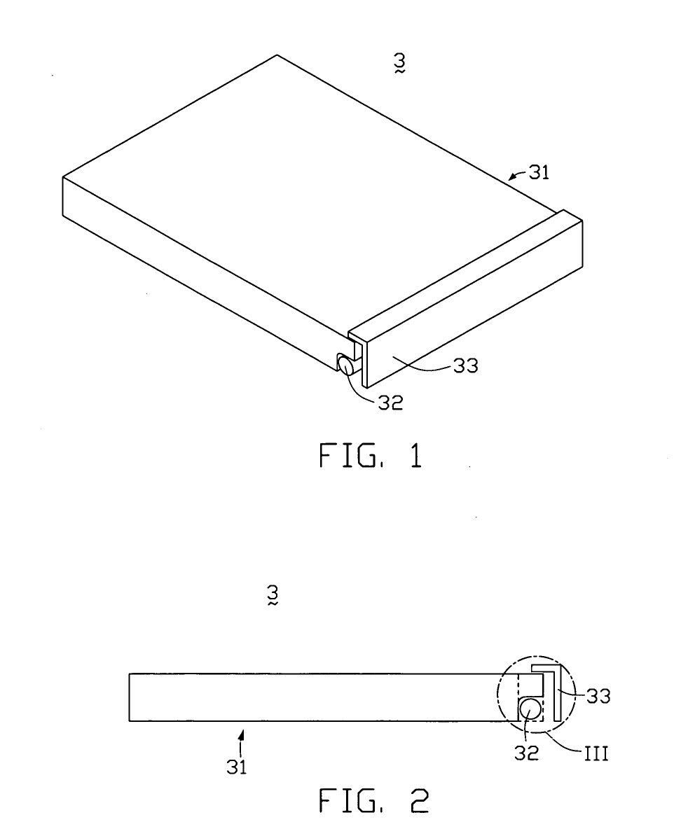

Referring to FIG. 1 and FIG. 2, a backlight module 3 according to a first embodiment of the present invention includes an LGP 31, a light source 32 disposed adjacent to the LGP 31, and a reflector 33 disposed adjacent to the light source 32.

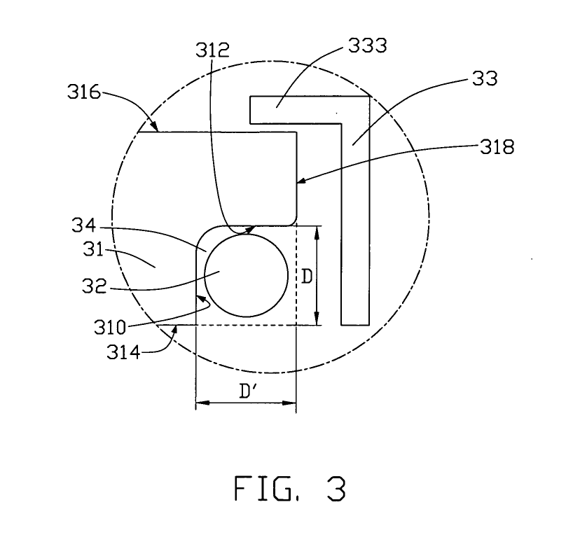

Referring also to FIG. 3, the LGP 31 includes a first light incident surface 310, a second light incident surface 312 adjoining the first light incident surface 310, a bottom surface 314 adjoining the first light incident surface 310, a light emitting surface 316 opposite to the bottom surface 314, and a side surface 318 adjoining both the second light incident surface 312 and the light emitting surface 316. The first light incident surface 310 and the second light incident surface 312 cooperatively define a groove 34 therebetween. The light emitting surface 316, the second light incident surface 312, and the bottom surface 314 are substantially parallel to each other. The LGP 31 can be made from polymethyl methacrylate (PMMA) or polycarbonate (PC).

A distance D between the second light incident surface 312 and the bottom surface 314 of the LGP 31 is equal to a distance D′ between the first light incident surface 310 and the side surface 318. The distance D is greater than a diameter of the light source 32. That is, the groove 34 defines a substantially square cross-sectional area, and the light source 32 can be accommodated in the groove 34.

The light source 32 is, in general, a cold cathode fluorescent lamp (CCFL). A top end 333 of the reflector 33 is attached at an end of the light emitting surface 316 of the LGP 31.

A portion of light beams emitted by the light source 32 enters the LGP 31 through the first light incident surface 310 and the second light incident surface 312. Another portion of the light beams travels to the reflector 33, and is reflected by the reflector 33 to the first light incident surface 310 and the second light incident surface 312.

Because the light source 32 is disposed in the groove 34, additional space for the light source 32 beyond the side surface 318 is not needed. Thus an overall length of the backlight module 3 can be shortened, providing a compact backlight module 3.

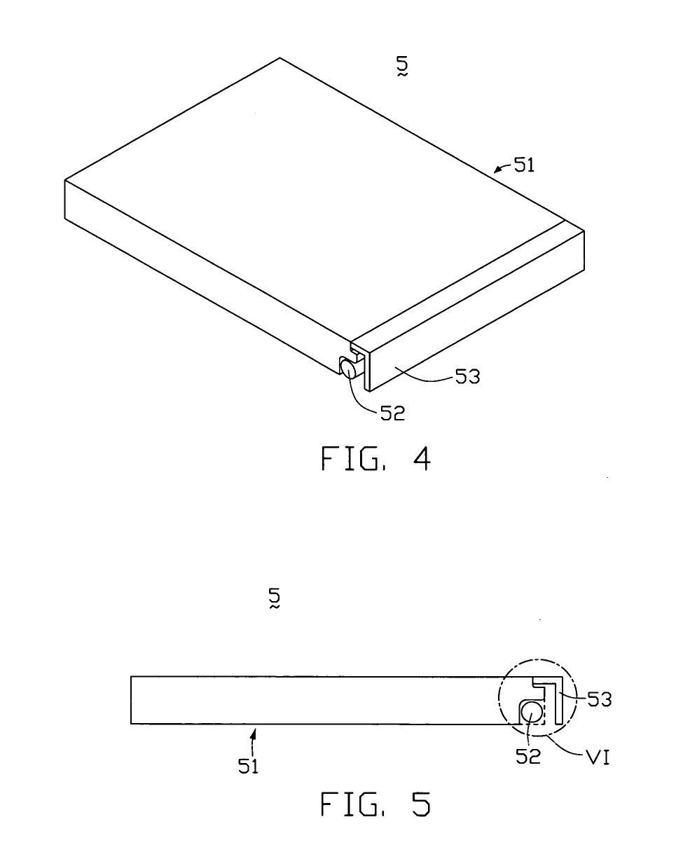

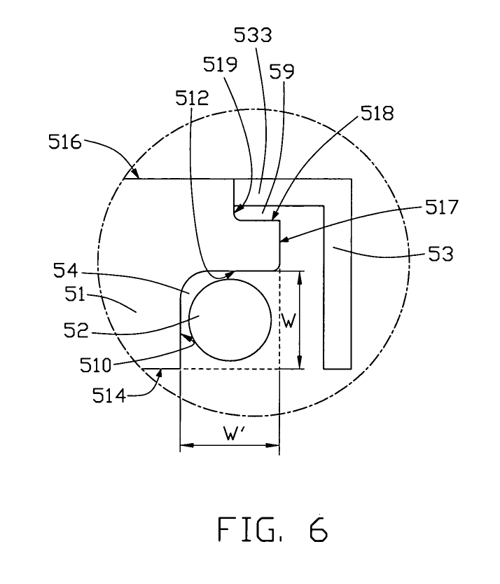

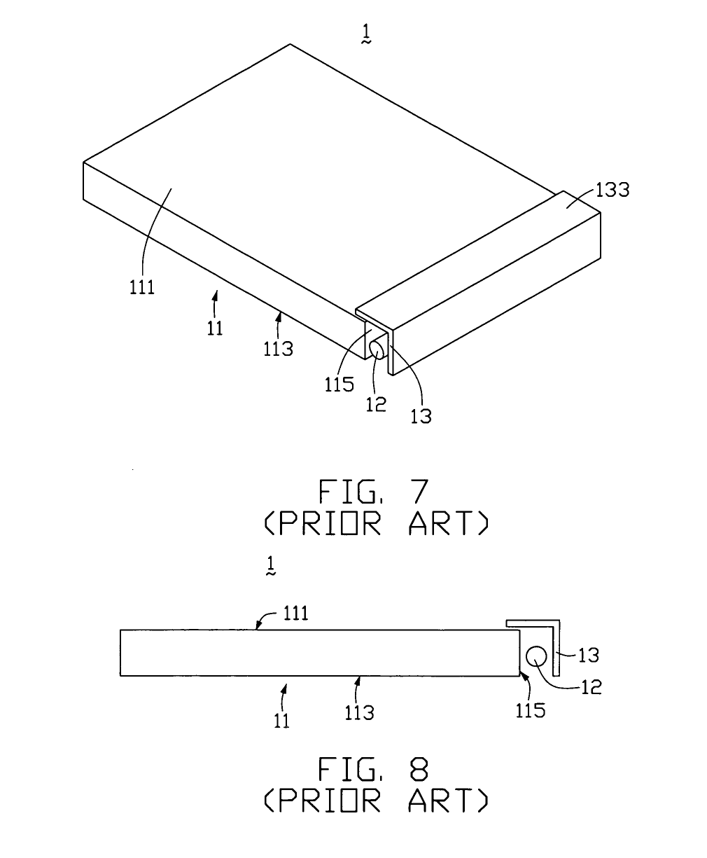

Referring to FIG. 4 and FIG. 5, a backlight module 5 according to a second embodiment of the present invention includes an LGP 51, a light source 52 disposed adjacent to the LGP 51, and a reflector 53 disposed adjacent to the light source 52.

Referring also to FIG. 6, the LGP 51 includes a first light incident surface 510, a second light incident surface 512 adjoining the first light incident surface 510, a bottom surface 514 adjoining the first light incident surface 510, and a light emitting surface 516 opposite to the bottom surface 514. The LGP 51 further includes a first side surface 517 adjoining the second light incident surface 512, a second side surface 518 adjoining the first side surface 517, and a third side surface 519 adjoining both the light emitting surface 516 and the second side surface 518. The first light incident surface 510 and the second light incident surface 512 cooperatively define a first groove 54 therebetween. The second side surface 518 and the third side surface 519 cooperatively define a second groove 59 therebetween. The light emitting surface 516, the second side surface 518, the second light incident surface 512 and the bottom surface 514 are substantially parallel to each other.

A distance W between the second light incident surface 512 and the bottom surface 514 of the LGP 51 is equal to a distance W′ between the first light incident surface 510 and the first side surface 517. The distance W is greater than a diameter of the light source 52. That is, the first groove 54 defines a substantially square cross-sectional area, and the light source 52 can be accommodated in the first groove 54.

A top end 533 of the reflector 53 is located in the second groove 59.

Because the light source 52 is disposed in the first groove 54, additional space for the light source 52 beyond the first side surface 517 is not needed. Thus an overall length of the backlight module 5 can be shortened. In addition, because the top end 533 of the reflector 53 is disposed in the second groove 59, additional space for the top end 533 beyond the light emitting surface 316 is not needed. Thus an overall height of the backlight module 5 can be shortened. With a reduced overall length and height, the backlight module 5 is compact.

In alternative embodiments, the second light incident surface 312, 512 can be inclined relative to the bottom surface 314, 514 of the LGP 31, 51. In another alternative embodiment, the second side surface 518 can directly adjoin the light emitting surface 516 of the LGP 51. In further alternative embodiments, the second side surface 518 can be inclined relative to the bottom surface 514 of the LGP 51.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module, comprising:
a light guide plate, comprising:
a first light incident surface;
a second light incident surface adjacent the first light incident surface, the first and second light incident surfaces cooperatively defining a first groove; and
a light source in the first groove.

2. The backlight module as claimed in claim 1, wherein the light guide plate further comprises a bottom surface adjacent the first light incident surface, and a light emitting surface opposite to the bottom surface.

3. The backlight module as claimed in claim 2, wherein the second light incident surface is parallel to the bottom surface.

4. The backlight module as claimed in claim 2, wherein the second light incident surface is inclined relative to the bottom surface.

5. The backlight module as claimed in claim 2, wherein a distance between the second light incident surface and the bottom surface is greater than a diameter of the light source.

6. The backlight module as claimed in claim 1, further comprising a reflector disposed adjacent to the light source.

7. The backlight module as claimed in claim 2, wherein the light guide plate further comprises a first side surface adjacent the second light incident surface, a second side surface adjacent the first side surface, and a third side surface adjacent both the light emitting surface and the second side surface.

8. The backlight module as claimed in claim 7, wherein the second side surface and the third side surface cooperatively define a second groove.

9. The backlight module as claimed in claim 8, wherein a top end of the reflector is at least partially located in the second groove.

10. The backlight module as claimed in claim 7, wherein the second side surface is substantially parallel to the bottom surface.

11. The backlight module as claimed in claim 7, wherein the second side surface is inclined relative to the bottom surface.

12. The backlight module as claimed in claim 1, wherein the light source is a cold cathode fluorescent lamp.
